(19) United States
(12) Patent Application Publication
(10) Pub. No.: US 2025/0089105 A1
(43) Pub. Date: Mar. 13, 2025

(54) IMPROVEMENTS IN AND RELATING TO A USER EQUIPMENT, UE

(71) Applicant: Samsung Electronics Co., Ltd., Suwon-si, Gyeonggi-do (KR)

(72) Inventors: Mahmoud WATFA, Staines (GB); Lalith KUMAR, Bangalore (IN)

(21) Appl. No.: 18/727,547

(22) PCT Filed: Feb. 9, 2023
(86) PCT No.: PCT/KR2023/001934

§ 371 Date: Jul. 9, 2024

(30) Foreign Application Priority Data
Feb. 9, 2022 (IN) 202231006896
Feb. 8, 2023 (GB) 2301770.0

(51) Int. Cl. H04W 76/10; H04W 76/38

(52) U.S. Cl. CPC H04W 76/10; H04W 76/38

(57) ABSTRACT

The disclosure relates to a 5G or 6G communication system for supporting a higher data transmission rate. Disclosed is a method of operating a User Equipment, the UE being operable in a first mode or a second mode, and being further operable to communicate with a telecommunication network, wherein in the first mode (EPS/S1) if: the UE receives a SERVICE ACCEPT message: the UE has set a Control plane service type of a CONTROL PLANE SERVICE REQUEST message to “mobile terminating request” and an “active” flag in the Control plane service type Information Element, IE, to 0); User Plane, UP, radio bearers have not been set up; and the CONTROL PLANE SERVICE REQUEST message was sent from EMM-IDLE mode, then the UE starts a timer to guard a time during which the UE remains in connected mode; and in the second mode (5GS/N1) if: the UE sends a CONTROL PLANE SERVICE REQUEST message; the UE did not set a Control plane service type IE to “emergency services fallback”; the UE has not included an Uplink data status IE in the CONTROL PLANE SERVICE REQUEST message, or the UE has included the Uplink data status IE in the CONTROL PLANE SERVICE REQUEST message but a received SERVICE ACCEPT message indicates that no user-plane resources of any PDU sessions are to be re-established, then the UE starts a timer to guard a time during which the UE remains in connected mode.

### TECHNICAL FIELD

The present invention is related to control of one or more certain timers in a User Equipment, UE, operable to communication with a telecommunication network. The timer or timers are provided to control certain operations in the UE. In certain circumstances in the prior art, it is possible that proper control of the timers cannot be provided which can have adverse effects, including, but not limited to, exhausting battery power due to prolonged periods in an incorrect operational state.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologics (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The UE starts timer T3440 when some conditions are met as specified in TS 24.301 V17.5.0. The timer T3440 guards the time during which the UE keeps the NAS connection and leaves the decision to the network to release the NAS signalling connection. Upon the expiry of T3440, the UE then releases the NAS signalling connection. The need to release the connection is because, for example, the UE detects that no data or signalling has arrived from the network for a specific time (e.g. 10 s) which then means that remaining in connected mode would drain power and so it is better to preserve power and enter idle mode. The different conditions that lead to the start of T3440 can be seen in section 5.3.1.2.1 of 3GPP TS 24.301 V17.5.0.

Note that a similar timer is used in 5GS, where the timer is referred to as T3540. Details of when this timer should be started is defined in section 5.3.1.3 of 3GPP TS 24.501 V17.5.0.

There is a problem with the prior art in that there is a missing case for which T3440 should be started: namely when responding to paging.

There is a particular case in which the UE should start T3440 but this case is missing in the prior art. The case is when the UE is responding to paging with the Control Plane, CP, Service Request message wherein the UE receives a Service Accept message without any User-Plane, UP, resources being established. In this case, if the UE does not start T3440, then the UE may end up remaining in connected mode for a long time and hence power will be wasted.

There are other possible cases for starting T3540 or T3440, as explained below.

The current specification, TS 24.501, does not consider the Control Plane Service Request for starting T3540. It only considers the Service Request message. However, this may be regarded as incorrect since the UE may send the Control Plane Service Request message and meet all the conditions that are defined in TS 24.501 in order to start T3540 with the Service Request message. This means that if the UE indeed sends the Control Plane Service Request message, then the UE will stay in connected mode for a longer time and waste battery resources.

Further, there is another case which is missing for which T3440 or T3540 is not started. This is when the UE sends a Control Plane Service Request message and indicates to the network that it has no more uplink data to send, nor any downlink data that is expected. If this occurs, then the UE will remain in connected mode for potentially a long time and drain battery resources.

### Solution to Problem

According to the present invention there is provided an apparatus and method as set forth in the appended claims. Other features of the invention will be apparent from the dependent claims, and the description which follows.

According to a first aspect of the present invention, there is provided a method of operating a User Equipment, the UE being operable in a first mode or a second mode, and being further operable to communicate with a telecommunication network, wherein in the first mode (EPS/S1) if:
the UE receives a SERVICE ACCEPT message;
the UE has set a Control plane service type of a CONTROL PLANE SERVICE REQUEST message to “mobile terminating request” and an “active” flag in the Control plane service type Information Element, IE, to 0;
User Plane, UP, radio bearers have not been set up; and
the CONTROL PLANE SERVICE REQUEST message was sent from EMM-IDLE mode, then the UE starts a timer to guard a time during which the UE remains in connected mode; and
in the second mode (5GS/N1) if:
the UE sends a CONTROL PLANE SERVICE REQUEST message;
the UE did not set a Control plane service type IE to “emergency services fallback”;
the UE has not included an Uplink data status IE in the CONTROL PLANE SERVICE REQUEST message, or the UE has included the Uplink data status IE in the CONTROL PLANE SERVICE REQUEST message but a received SERVICE ACCEPT message indicates that no user-plane resources of any PDU sessions are to be re-established, then the UE starts a timer to guard a time during which the UE remains in connected mode.

In an embodiment, additionally in the second mode, the timer is started if:
the UE has not included an Allowed PDU session status IE or has included the Allowed PDU session status IE indicating there is no PDU session for which the UE allowed a user-plane resource to be re-established over 3GPP access in the SERVICE REQUEST message or the CONTROL PLANE SERVICE REQUEST message; or
the UE has included the Allowed PDU session status IE in the SERVICE REQUEST message or the CONTROL PLANE SERVICE REQUEST message but the SERVICE ACCEPT message does not indicate that any user-plane resources of any PDU sessions are to be re-established.

In an embodiment, the first mode is EPS or S1, and the second mode is 5GS or N1.

In an embodiment, the timer in the first mode is T3440, and the timer in the second mode is T3540.

According to a second aspect of the present invention, there is provide a UE operable to perform the method of the first aspect.

In accordance with an aspect of the disclosure, a method performed by a User Equipment (UE) in a wireless communication system, the method comprising, transmitting, to a network, a SERVICE REQUEST message, wherein the SERVICE REQUEST message is a CONTROL PLANE SERVICE REQUEST message; receiving, from the network, a SERVICE ACCEPT message; and starting a timer when a condition is met.

In an embodiment of the disclosure, wherein the condition is that the SERVICE ACCEPT message is received, the UE has set the Control plane service type of the CONTROL PLANE SERVICE REQUEST message to “mobile terminating request” and the “active” flag in the Control plane service type IE to 0, the user plane radio bearers have not been set up, and the CONTROL PLANE SERVICE REQUEST message was sent from EMM-IDLE mode.

In an embodiment of the disclosure, wherein the timer is T3440.

In an embodiment of the disclosure, wherein the condition is that the CONTROL PLANE SERVICE REQUEST message is sent, the UE did not set the Control plane service type IE to “emergency services fallback”, the UE has not included the Uplink data status IE in the CONTROL PLANE SERVICE REQUEST message, or the UE has included the Uplink data status IE in the CONTROL PLANE SERVICE REQUEST message but the SERVICE ACCEPT message indicates that no user-plane resources of any PDU sessions are to be re-established.

In an embodiment of the disclosure, wherein the condition is that the UE has not included the Allowed PDU session status IE or has included the Allowed PDU session status IE indicating there is no PDU session(s) for which the UE allowed the user-plane resource to be re-established over 3GPP access in the SERVICE REQUEST message or the CONTROL PLANE SERVICE REQUEST message, or the UE has included the Allowed PDU session status IE in the SERVICE REQUEST message or the CONTROL PLANE SERVICE REQUEST message but the SERVICE ACCEPT message does not indicate that any user-plane resources of any PDU sessions are to be re-established.

In an embodiment of the disclosure, wherein the timer is T3540.

In accordance with another aspect of the disclosure, a method performed by a network in a wireless communication system, the method comprising, receiving, to a User Equipment (UE), a SERVICE REQUEST message, wherein the SERVICE REQUEST message is a CONTROL PLANE SERVICE REQUEST message; and transmitting, from the network, a SERVICE ACCEPT message, wherein a timer is stared when a condition is met.

In accordance with another aspect of the disclosure, a User Equipment (UE), the UE comprising: a transceiver; and a controller coupled with the transceiver and configured to control to: transmit, to a network, a SERVICE REQUEST message, wherein the SERVICE REQUEST message is a CONTROL PLANE SERVICE REQUEST message, receive, from the network, a SERVICE ACCEPT message, and start a timer when a condition is met.

In accordance with another aspect of the disclosure, a network, the network comprising: a transceiver; and a controller coupled with the transceiver and configured to control to: receive, to a User Equipment (UE), a SERVICE REQUEST message, wherein the SERVICE REQUEST message is a CONTROL PLANE SERVICE REQUEST message, and transmit, from the network, a SERVICE ACCEPT message, wherein a timer is stared when a condition is met.

Although a few preferred embodiments of the present invention have been shown and described, it will be appreciated by those skilled in the art that various changes and modifications might be made without departing from the scope of the invention, as defined in the appended claims.

### ADVANTAGEOUS EFFECTS OF INVENTION

It is an aim of embodiments of the present invention to define certain conditions to avoid wasting battery resources, in particular. Other problems, not set out above may be addressed or overcome, at least in part.

### BRIEF DESCRIPTION OF DRAWINGS

For a better understanding of the invention, and to show how embodiments of the same may be carried into effect, reference will now be made, by way of example only, to the accompanying diagrammatic drawings in which:

FIG. 1 shows a flowchart illustrating the operation of an embodiment of the invention.

FIG. 2 shows the configuration of a user equipment (UE) according to an embodiment of the disclosure.

FIG. 3 shows the configuration of a network according to an embodiment of the disclosure.

### MODE FOR THE INVENTION

An embodiment of the present invention defines a set of new conditions for starting timer T3440. In this embodiment, the UE should start timer T3440 when any combination of the following conditions are met, where the conditions may be verified in any order:
a) the UE receives a SERVICE ACCEPT message
b) the UE sent a CONTROL PLANE SERVICE REQUEST message optionally from EMM-IDLE mode (or from EMM-IDLE mode with suspend indication)
c) the Control plane service type indicated “mobile terminating request” (or the Control plane service type did not indicate “mobile originating request”)
d) the “Active” flag bit in the Control plane service type IE is set to “No radio bearer establishment requested” i.e. it is set to the value 0 (or the “Active” flag bit in the Control plane service type IE is not set to “Radio bearer establishment requested” i.e. the “Active” flag bit in the Control plane service type IE is not set to the value 1)
   i. Alternatively, the “Active” flag bit in the Control plane service type IE is set to “Radio bearer establishment requested” i.e. the “Active” flag bit in the Control plane service type IE is set to the value 1.
   ii. Alternatively, the value of the “Active” flag bit in the Control plane service type IE is not relevant i.e. its value or the entire bit itself may be ignored
e) the user plane radio bearers have not been set up
f) the UE is using control plane CIOT EPS optimization
g) Optionally, the Control Plane Service Request message did not include the ESM message container IE (or the NAS message container IE)

h) Optionally, the Control Plane Service Request message did include the ESM message container IE but the DDX field in the Release assistance indication IE is set to a value that indicates “No further uplink and no further downlink data transmission subsequent to the uplink data transmission is expected”

Further, if some or all of the conditions above are met, the UE can/should start T3440. Note that this means that the UE may also check for other conditions in addition to those listed above and then the UE starts the timer T3440 when the conditions are met. As such, the conditions listed above may not be exhaustive for all the cases which may arise in the future. Note that some of the conditions above may also be different, where for example, the value of an IE may be any value and not just limited to one value. For example, any combination of the conditions may be considered in addition to Control plane service type field taking any value.

Note that the UE may start T3440 when a subset (or any combination, where it may be at least one condition) of the conditions above is met i.e. not all of the conditions above need to be met but a subset (in any combination) of them may be sufficient to start T3440.

The UE may stop (and optionally restart) the timer T3440 when any combination of the following occurs:
a) the UE receives any NAS message, such as, but not limited to, ACTIVATE DEFAULT EPS BEARER CONTEXT REQUEST, MODIFY EPS BEARER CONTEXT REQUEST, DEACTIVATE EPS BEARER CONTEXT REQUEST, DOWNLINK NAS TRANSPORT or DOWNLINK GENERIC NAS TRANSPORT message
b) the UE receives the ESM DATA TRANSPORT message
c) the user plane radio bearers are set up

The UE may then use the existing NAS signalling connection to send uplink signalling via the existing NAS signalling connection.

Note that the details set out above can also be applicable to N1 mode, where the same or substantially similar conditions can be checked and the timer T3540 can be started when the relevant conditions are met.

In a further embodiment, the prior art conditions defined in TS 24.501 are also applicable to the Control Plane Service Request message. Here, the UE should also start T3540 when any of the following conditions are met, in any order or combination:
a) the UE receives a SERVICE ACCEPT message;
b) the UE set the Control plane service type IE to “mobile terminating request” (or did not set the Control plane service type IE to “mobile originating request”, or did not set it to “emergency services”, or did not set it to “emergency services fallback”), the UE has not included the Uplink data status IE in the CONTROL PLANE SERVICE REQUEST message, or the UE has included the Uplink data status IE in the CONTROL PLANE SERVICE REQUEST message but the SERVICE ACCEPT message indicates that no user-plane resources of any PDU sessions are to be re-established;
c) the UE has not included the Allowed PDU session status IE in the CONTROL PLANE SERVICE REQUEST message, or has included the Allowed PDU session status IE indicating there is no PDU session(s) for which the UE allowed the user-plane resource to be re-established over 3GPP access in the CONTROL PLANE SERVICE REQUEST message, or the UE has included the Allowed PDU session status IE in the CONTROL SERVICE REQUEST message but the SERVICE ACCEPT message does not indicate that any user-plane resources of any PDU sessions are to be re-established;
d) the service request procedure has been initiated in 5GMM-IDLE mode;
e) the user-plane resources for PDU sessions have not been set up;
f) the UE need not request resources for V2X communication over PC5 reference point (see 3GPP TS 23.287 [6C]); and
g) the UE need not request resources for ProSe direct discovery over PC5 or ProSe direct communication over PC5 (sec 3GPP TS 23.304);

Note that the lower layers indicate when the user-plane resources for PDU sessions are successfully established or released.

Note, also, that the above conditions are meant as an example, and a subset of the above may be verified. It should also be noted that the order of verifying the conditions may vary i.e. the order in which the various conditions are verified is not significant to the operation of any particular embodiment. It should also be noted that at least any combination of the above can be verified, in addition to other conditions that can be introduced later. Once these conditions are met, the UE should start T3540.

In this case, the UE may stop (and optionally restart) the timer T3540 when any combination of the following occurs:
a) the UE receives any NAS message
b) the user plane radio bearers are set up or the user resources are set up

The UE may then use the existing NAS signalling connection to send uplink signalling via the existing NAS signalling connection.

In a still further embodiment, there are certain other conditions which may be evaluated or used to start T3440 or T3540, as appropriate.

The UE should start timer T3440 (in S1 mode) or T3540 (in N1 mode) when any of the following conditions are met, in any order or combination:
a) the UE receives a SERVICE ACCEPT message
b) the UE sent a CONTROL PLANE SERVICE REQUEST message from EMM-IDLE mode (or EMM-IDLE mode with suspend indication) for the case of S1 mode, or from 5GMM-IDLE mode (or 5GMM-IDLE mode with suspend indication) for the case of N1 mode
c) the Control plane service type indicated “mobile originating request” (or it did not indicate “mobile terminating request”)
d) the “Active” flag bit in the Control plane service type IE is set to “No radio bearer establishment requested” i.e. it is set to the value 0 (or the “Active” flag bit in the Control plane service type IE is not set to “Radio bearer establishment requested” i.e. the “Active” flag bit in the Control plane service type IE is not set to the value 1). Note that this is applicable to S1 mode only
e) The UE did not include the Uplink data status IE in the Control Plane Service Request message. Note that this is applicable to N1 mode only
f) the user plane radio bearers, or user plane resources, have not been set up
g) the UE is using control plane CIOT EPS optimization in S1 mode, or the UE is using control plane CIoT 5GS optimization in N1 mode
h) The DDX field in the Release assistance indication IE is set to a value that indicates “No further uplink and no further downlink data transmission subsequent to the uplink data transmission is expected” i.e. it is set to the value ‘01’
   i. Note that in S1 mode, this field is in the ESM DATA TRANSPORT message
   ii. Note that in N1 mode, this field is in the CIoT small data container IE, or in the Release assistance indication IE that is part of the Control Plane Service Request message

Further, when one or more of the conditions above are met, the UE can start T3440 or T3540. This means that the UE may also check for other conditions in addition to those listed above and then the UE starts the timer T3440 or T3540 when the conditions are met. As such, the conditions listed above are not intended to be exhaustive for all the cases which may arise in the future. Note that some of the conditions above may also be different, where for example, the value of an IE may be any value and not just limited to one value. For example, any combination of the conditions may be considered in addition to Control plane service type field taking any value.

In this case, the UE may stop (and optionally restart) the timer T3440 or T3540 when any combination of the following occurs:
a) the UE receives any NAS message
b) the user plane radio bearers are set up or the user resources are set up

The UE may then use the existing NAS signalling connection to send uplink signalling via the existing NAS signalling connection.

Note that for all of the procedures set out herein, the UE should enter EMM-IDLE mode when timer T3440 expires in S1 mode, or the UE should enter 5GMM-IDLE mode when T3540 expires in N1 mode.

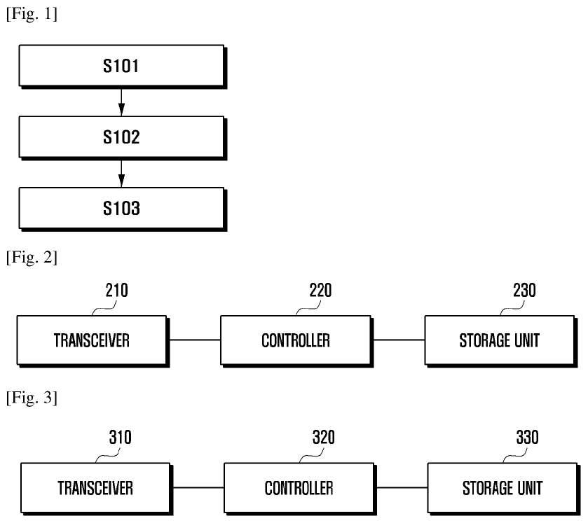

FIG. 1 shows a representation of the operation of an embodiment of the present invention. At step S101, the UE is operable in one of a first mode (EPS) and second mode (5GS). At step S102, one or more conditions are checked, as set out in the foregoing and if true, the appropriate timer (T3440 or T3540, as appropriate) is started to guard a time during which the UE remains in connected mode.

FIG. 2 shows the configuration of a user equipment (UE) according to an embodiment of the disclosure.

Referring to FIG. 2, the UE may include a transceiver 210, a controller 220, and a storage unit 230. In the embodiment, the controller 220 may be defined as a circuit, an application-specific integrated circuit, or at least one processor.

The transceiver 210 may transmit/receive signals to/from other network entities. The controller 220 may control overall operations of the UE according to the embodiment proposed in the disclosure. The storage unit 230 may store at least one piece of information transmitted/received through the transceiver 210 and information produced through the controller 220.

FIG. 3 shows the configuration of a network according to an embodiment of the disclosure. The network may correspond to the RAN node in the respective embodiments.

Referring to FIG. 3, the base station may include a transceiver 310, a controller 320, and a storage unit 330. In the embodiment, the controller 320 may be defined as a circuit, an application-specific integrated circuit, or at least one processor.

The transceiver 310 may transmit/receive signals to/from other network entities. The controller 320 may control overall operations of the base station according to the embodiment proposed in the disclosure. The storage unit 330 may store at least one piece of information transmitted/received through the transceiver 310 and information produced through the controller 320.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method performed by a User Equipment (UE) in a wireless communication system, the method comprising,
transmitting, to a network, a SERVICE REQUEST message, wherein the SERVICE REQUEST message is a CONTROL PLANE SERVICE REQUEST message;
receiving, from the network, a SERVICE ACCEPT message; and
starting a timer when a condition is met.

2. The method of claim 1, wherein the condition is that the SERVICE ACCEPT message is received, the UE has set the Control plane service type of the CONTROL PLANE SERVICE REQUEST message to “mobile terminating request” and the “active” flag in the Control plane service type IE to 0, the user plane radio bearers have not been set up, and the CONTROL PLANE SERVICE REQUEST message was sent from EMM-IDLE mode.

3. The method of claim 1, wherein the timer is T3440.

4. The method of claim 1, wherein the condition is that the CONTROL PLANE SERVICE REQUEST message is sent, the UE did not set the Control plane service type IE to “emergency services fallback”, the UE has not included the Uplink data status IE in the CONTROL PLANE SERVICE REQUEST message, or the UE has included the Uplink data status IE in the CONTROL PLANE SERVICE REQUEST message but the SERVICE ACCEPT message indicates that no user-plane resources of any PDU sessions are to be re-established.

5. The method of claim 1, wherein the condition is that the UE has not included the Allowed PDU session status IE or has included the Allowed PDU session status IE indicating there is no PDU session(s) for which the UE allowed the user-plane resource to be re-established over 3GPP access in the SERVICE REQUEST message or the CONTROL PLANE SERVICE REQUEST message, or the UE has included the Allowed PDU session status IE in the SERVICE REQUEST message or the CONTROL PLANE SERVICE REQUEST message but the SERVICE ACCEPT message does not indicate that any user-plane resources of any PDU sessions are to be re-established.

6. The method of claim 1, wherein the timer is T3540.

7. A method performed by a network in a wireless communication system, the method comprising,
receiving, to a User Equipment (UE), a SERVICE REQUEST message, wherein the SERVICE REQUEST message is a CONTROL PLANE SERVICE REQUEST message; and
transmitting, from the network, a SERVICE ACCEPT message, wherein a timer is stared when a condition is met.

8. The method of claim 7, wherein the condition is at least one of:
the SERVICE ACCEPT message is sent, the UE has set the Control plane service type of the CONTROL PLANE SERVICE REQUEST message to “mobile terminating request” and the “active” flag in the Control plane service type IE to 0, the user plane radio bearers have not been set up, and the CONTROL PLANE SERVICE REQUEST message was sent from EMM-IDLE mode,
the CONTROL PLANE SERVICE REQUEST message is received, the UE did not set the Control plane service type IE to “emergency services fallback”, the UE has not included the Uplink data status IE in the CONTROL PLANE SERVICE REQUEST message, or the UE has included the Uplink data status IE in the CONTROL PLANE SERVICE REQUEST message but the SERVICE ACCEPT message indicates that no user-plane resources of any PDU sessions are to be re-established, or
the UE did not set the Control plane service type IE to “emergency services fallback”, the UE has not included the Uplink data status IE in the CONTROL PLANE SERVICE REQUEST message, or the UE has included the Uplink data status IE in the CONTROL PLANE SERVICE REQUEST message but the SERVICE ACCEPT message indicates that no user-plane resources of any PDU sessions are to be re-established

9. A User Equipment (UE), the UE comprising:
a transceiver; and
a controller coupled with the transceiver and configured to control to:
transmit, to a network, a SERVICE REQUEST message, wherein the SERVICE REQUEST message is a CONTROL PLANE SERVICE REQUEST message, receive, from the network, a SERVICE ACCEPT message, and start a timer when a condition is met.

10. The UE of claim 1, wherein the condition is that the SERVICE ACCEPT message is received, the UE has set the Control plane service type of the CONTROL PLANE SERVICE REQUEST message to “mobile terminating request” and the “active” flag in the Control plane service type IE to 0, the user plane radio bearers have not been set up, and the CONTROL PLANE SERVICE REQUEST message was sent from EMM-IDLE mode.

11. The UE of claim 1, wherein the timer is T3440.

12. The UE of claim 1, wherein the condition is that the CONTROL PLANE SERVICE REQUEST message is sent, the UE did not set the Control plane service type IE to “emergency services fallback”, the UE has not included the Uplink data status IE in the CONTROL PLANE SERVICE REQUEST message, or the UE has included the Uplink data status IE in the CONTROL PLANE SERVICE REQUEST message but the SERVICE ACCEPT message indicates that no user-plane resources of any PDU sessions are to be re-established.

13. The UE of claim 1, wherein the condition is that the UE has not included the Allowed PDU session status IE or has included the Allowed PDU session status IE indicating there is no PDU session(s) for which the UE allowed the user-plane resource to be re-established over 3GPP access in the SERVICE REQUEST message or the CONTROL PLANE SERVICE REQUEST message, or the UE has included the Allowed PDU session status IE in the SERVICE REQUEST message or the CONTROL PLANE SERVICE REQUEST message but the SERVICE ACCEPT message does not indicate that any user-plane resources of any PDU sessions are to be re-established.

14. The UE of claim 1, wherein the timer is T3540.

15. A network, the network comprising:
a transceiver; and
a controller coupled with the transceiver and configured to control to:
receive, to a User Equipment (UE), a SERVICE REQUEST message, wherein the SERVICE REQUEST message is a CONTROL PLANE SERVICE REQUEST message, and transmit, from the network, a SERVICE ACCEPT message,
wherein a timer is stared when a condition is met.
